(19) United States
(12) Patent Application Publication
(10) Pub. No.: US 2004/0228403 A1
(43) Pub. Date: Nov. 18, 2004

(54) Moving picture coding method

(75) Inventor: Jae Shin Yu, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/842,501

(22) Filed: May 11, 2004

(30) Foreign Application Priority Data
May 12, 2003 (KR) 2003/29854

(51) Int. Cl. H04N 7/12

(52) U.S. Cl. 375/240.03; 375/240.01; 375/240.2; 375/240.27

(57) ABSTRACT

There is provided a moving picture coding method, which is capable of effectively processing error concealment through data hiding. The moving picture coding method includes the steps of: extracting an information on region of interest (ROI) of an inputted image at an encoder; transmitting the extracted information on the ROI through data hiding; and performing an error concealment using the information on the ROI at a decoder.

### BACKGROUND OF THE INVENTION

1. Field of the Invention

The present invention relates to a moving picture coding method, and more particularly, to a moving picture coding method, which is capable of efficiently processing error concealment through data hiding.

2. Description Of the Related Art

As very high speed mobile communications such as IMT-2000 are visualized, multimedia services such as voice, still picture and moving picture are widely expanded. Examples of the moving picture multimedia services are one-way service such as VOD and bi-directional service such as video communication. Video communication basically performs a video compression because it has a larger quantity of data than the voice communication.

A moving picture coding method according to the related art will now be described with reference to FIG. 1. Referring to FIG. 1, motion estimation and motion compensation are performed to an input image to extract motion vector. Then, discrete cosine transform (DCT) and quantization are performed to a difference image. Variable length coding (VLC) is performed to the quantized data in order for more efficient data compression.

An original image is restored by adding the previous image and the inverse quantized and inverse DCTed image. A difference image of next image is obtained using the restored image. In this manner, video data compression is achieved.

After the video data compression, a communication with the other party is performed through a network. At this point, noise occurs in the data transmission network. In other words, communication data are not intactly transmitted to a receiver terminal, and data damage or loss occurs. Such damage or loss of the transmission data is referred to as error.

Such an error has an influence on corresponding error frame and following frames. The reason is because the compression, is performed to video data. In spatiotemporal motion estimation, one-time occurrence of data error affects consecutive frames. Additionally, when data error occurs, the variable length coding loses synchronization (Sync) and affects the frames until next synchronization is found. In other words, due to the video compression, the degradation of picture quality according to the data loss becomes very serious and occurs consecutively.

Such degradation of picture quality is a great obstacle to the moving picture services. While error recovery and error concealment methods are provided in video compression standard, the respective methods have limitations.

The error recovery methods are mainly performed through an additional data embedding at an encoder. When an error occurs, error propagation can be prevented at a decoder. In other words, the error propagation can be prevented by additionally embedding synchronization bits into the encoding streams or by segmenting the streams into blocks with the same length.

Another error recovery method is to operate a coder and decoder at the same time. This method uses a back channel. If the decoder notifies the encoder of a position where an error occurs, the encoder performs an error recovery using the information (that is, the position where the error occurs).

Meanwhile, the error, concealment method is performed at the decoder. According to this method, the region where an error occurs is made to be maximally similar to the original image using an image contained in the decoder.

However, the error recovery and concealment methods have disadvantages in that all errors are not eliminated.

### SUMMARY OF THE INVENTION

Accordingly, the present invention is directed to a moving picture coding method that substantially obviates one or more problems due to limitations and disadvantages of the related art.

An object of the present invention is to provide a moving picture coding method, in which an information on region of interest(ROI) is provided through data hiding in an encoding process when multimedia images are transmitted through a network, thereby efficiently processing error concealment with respect to an error occurring in a decoding process.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a moving picture coding method includes the steps of extracting an information on region of interest (ROI) of an inputted image at an encoder; transmitting the extracted information on the ROI through data hiding; and performing an error concealment using the information on the ROI at a decoder.

The moving picture coding method may further include the step of extracting the information on the ROI from the data hiding at the decoder before the error concealment is performed.

The information on the ROI may include a position of the ROI, a motion vector, and an information on the encoding type.

The data hiding repeatedly hides a header information of the ROI two or more times.

The data hiding may be performed using a quantization parameter with respect to the inputted image and/or a level value of a block in which DCT (discrete cosine transform) is performed. The level value is given by dividing DCT coefficient by the quantization parameter.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view of a related art coding process;

FIG. 2 is a view of a data hiding using a quantization parameter in a moving picture coding method according to the present invention;

FIG. 3 is a view of a data hiding using a level value in a moving picture coding method according to the present invention;

FIG. 4 is an exemplary view of macroblock-based ROI in a video communication, showing a user's face and body and a user region; and

FIG. 5 is a flowchart illustrating a moving picture coding method according to the present invention.

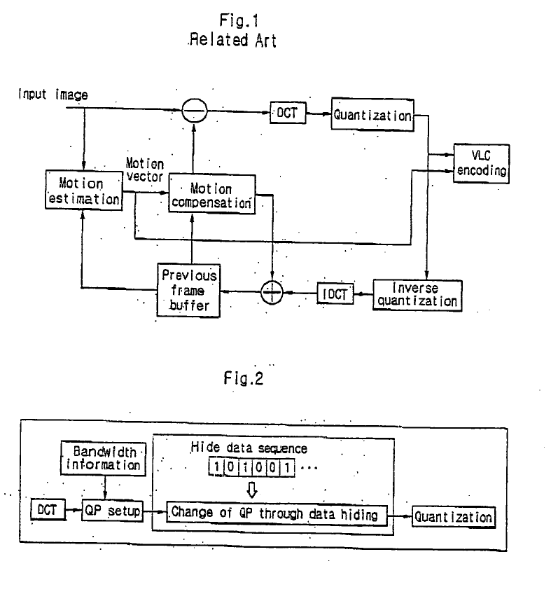

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

According to the present invention, important information on region of interest (hereinafter, referred to as ROI) is imperceptibly transmitted to a user through data hiding in an encoding process. Therefore, in case an error occurs, an error concealment can be processed more effectively at a decoder.

First, data hiding will now be described below.

Data hiding is a technology that hides information in digital, multimedia and, if necessary, extracts the hidden information. The data hiding can be largely classified into two categories. One requires an original image and the other does not require an original image when the hidden information is extracted. The data hiding that does not require the original image is be used in this invention.

In this invention, the data hiding is performed in the video compression. When the input image is compressed, the data hiding can be performed using parameters, which are used in the data compression, or by changing values that are dependent on the input image. In order to achieve the data hiding in the video compression, there must be values that do not affect the picture quality or amount of compressing data, even if original parameter or data are changed through the data hiding. Such values are quantization parameter (QP) and “level” value. The level value is given by dividing DCT coefficient by quantization parameter.

FIG. 2 illustrates the data hiding using the quantization parameter in the moving picture coding method according to the present invention.

As is well known, it is the quantization parameter that adjusts an amount of encoding data. The quantization parameter is a parameter that is used to divide the input image or its difference value by DCT coefficient. If the quantization parameter increases, a value divided by the DCT coefficient becomes large, so that an amount of the encoding data decreases. On the contrary, if the quantization parameter decreases, a value divided by the DCT coefficient becomes small, so that an amount of the encoding data increases.

When the video moving pictures are received and transmitted through a network, data are compressed to match with bandwidth of the network. If the bandwidth of the network is wide, an amount of communication data becomes large, so that an encoding amount increases and thus the picture quality is improved. On the contrary, if the bandwidth of the network is narrow, an amount of communication data becomes small, so that an encoding amount decreases and thus the picture quality is degraded. Considering these network conditions, the amount of the encoding data is adjusted using the quantization parameter. At this point, the data hiding is performed.

Referring to FIG. 2, the discrete cosine transform (DCT) is performed to the input image or its difference image and then an appropriate quantization parameter is set, considering the bandwidth of the network. The quantization parameter is used to decode the compressed image after entering a macroblock header. At this point, the data hiding is performed before the quantization is carried out using the quantization parameter. Here, the data hiding can be performed as follows:

QP_new % 2==Hide bit[k]

QP_new: No change

QP_new % 2!=Hide bit[k]

QP_new=QP_new+1;

Hide bit [k]: bit stream of data to be hidden

If the data hiding is performed in the above manner, the hidden data can be extracted based on the quantization parameter while the decoder decades the compressed data. If the quantization parameter in the decoder is an even number, the hidden data becomes “0”, and if the quantization parameter is an odd number, the hidden data becomes “1”.

At this point, the quantization parameter is slightly changed at the encoder in order for the data hiding. In other words, when the data to be hidden, and the quantization parameter are divided by 2, if the remainders are equal to each other, the value of the quantization parameter increases by 1, thereby making the remainders equal to each other. In this case, the divisor of the DCT coefficient increases, so that an amount of the encoding data is reduced. However, human's eyes cannot almost recognize the degradation of the picture quality.

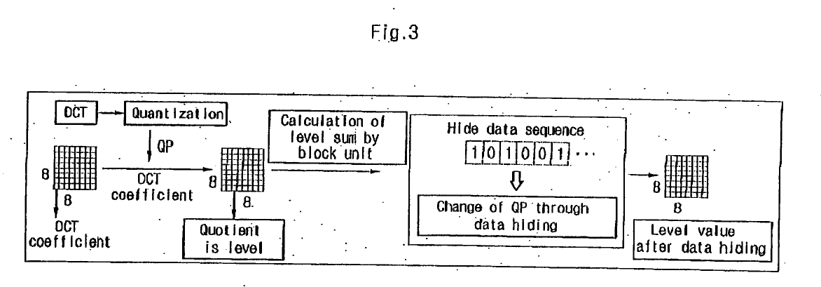

FIG. 3 is a view of a data hiding process using the level value in the moving picture coding method according to the present invention. In other words, in FIG. 3, data hiding is performed to the “level”, value, which is given by quantizing the DCT coefficient of the input image or difference image.

According to the moving picture coding method of the present invention, the DCT is performed to the input image or difference image for the purpose of compression. Then, considering the transmission bandwidth, the quantization parameter is assigned to adjust an amount of encoding bit. The DCT coefficient is divided by the quantization parameter.

In FIG. 3, the DCT is performed by 8×8 block unit. The quantization parameter is applied to the DCTed block and the coefficient is divided. When the coefficient is divided by the quantization parameter, the resultant quotient is referred to as “level”. The data hiding is performed using the levels produced at each block. Here, the data hiding can be expressed as follows:

LevelSum % 2==Hide, Bit[k]

Level: No change

LevelSum % 2!=Hide Bit[k]

A value of a level having the lowest significance decreases by 1

LevelSum: Sum of all levels of blocks.

The reason why the data hiding is performed not in the respective levels but in the sum of levels by block unit is that the picture quality is affected when the data hiding is performed to the respective levels. As the quantization parameter becomes larger, one level's range of DCT coefficient becomes wider, because the level is the quotient of the value given by dividing the DCT coefficient by the quantization parameter.

For example, in case the level values are equal to 1, if the quantization parameter is 10, the available DCT coefficient ranges from 10 to 19, and if the quantization parameter is 30, the available DCT coefficient ranges from 30 to 59. Thus, when the sum of the levels is calculated by 8×8 block unit and divided by 2, if the resultant remainder and the data bit to be hidden are equal to each other, the level is not changed, and if not, a value of a level having the lowest significance decreases by 1.

Here, the level having the lowest significance represents a region having the least sensitivity to human's eyes. Meanwhile, human's eyes are least sensitive to high frequency range. Therefore, if the data bit to be hidden and the remainder made by dividing the “level sum” by 2 are not equal to each other, the value of the level having the highest frequency decreases by 1.

If the “level sum” is “16” and the bit to be embedded is “1” the value of the “level” corresponding to the highest frequency block among the blocks decreases by “1”. Thus, the “level sum” becomes “15”, so that the bit to be hidden and the remainder given by dividing the “level sum” by 2 are made to be equal to each other.

However, a problem occurs when the “level sum” is “1”. If the “level sum” is “1” and the bit to be hidden is “1”, a sum of the total blocks becomes “0” when the level value of the region having the lowest sensitivity decreases by 1. however, since the level of the block whose original sum is “0” cannot be decreased any more, the data hiding is not performed. In this case, the block whose “level sum” is changed from “1” to “0” through the data hiding cannot be distinguished from the block whose original “level sum” is “0” and having no data hiding.

The present invention makes use of a following method in order to prevent these errors.

In case the “level sum” is “1” and the data to be hidden is “1”, data is embedded into the corresponding block. In this case, the “level sum” is not changed. In case the “level sum” is “1” and the data to be hidden is “0”, the “level sum” of the corresponding block is changed to “0” and the data hiding is not performed. When the “level sum” is “0”, the decoder considers that there is no data hiding in the corresponding block.

In this manner, if the data to be hidden and the remainder made by dividing a sum of the blocks by 2 are equal to each other, the levels of all the blocks, except for the block having the “level sum” of “1”, are not changed, and if not, the data can be hidden by decreasing the level of the region having the lowest sensitivity by 1.

In case of the block having the “level sum” is “1”, if the data to be hidden is “1”, the data is hidden. On the contrary, if the data to be hidden is “0”, the data is not hidden, but only the level value of the block is changed to “0”. When the “level sum” is “0”, the data hiding is not performed.

Meanwhile when the data hiding is performed using the quantization parameter or the level value, the data hiding is performed to the information on ROI in the incoming images.

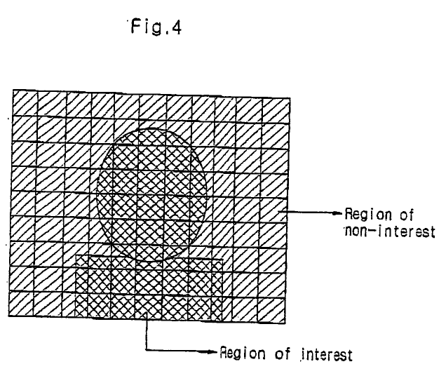

The ROI represents a region to which a user responds most sensitively to a variation of the picture quality, for example faces of persons who communicate in a video communication, as shown in FIG. 4. FIG. 4 is an exemplary view of the ROI in a video communication by macroblock unit, showing a user's face and body and a user region.

When an error occurs in the ROI such as the user region, the user recognizes greatly the degradation of the picture quality. As described above, in case of the video compression using the motion estimation and the motion compensation, the error is propagated to the consecutive frames. As a result, the error is getting accumulated much more at following frames, resulting in more degradation of the picture quality. In order to prevent such a degradation of the picture quality, the error concealment is performed at the decoder. However, since there are no ROI and information on other regions, a simple error concealment method is performed and thus the error concealment becomes inaccurately.

In order to overcome these drawbacks, the information on the ROI is extracted at the encoder and the data hiding is performed to the information on the ROI in the encoding process. The information on the ROI can be easily extracted using an object extraction technology. In the data hiding, an amount of encoding data must not increase and the picture quality must not be changed. The position satisfying these requirements is the quantization parameter and the level value given by dividing the DCT coefficient by the quantization parameter.

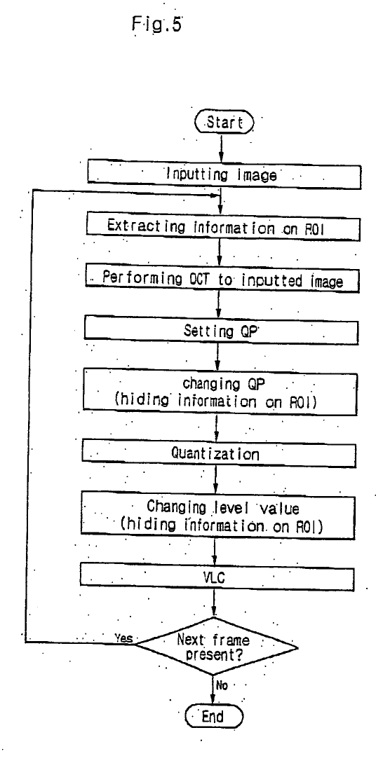

In this invention, after the quantization parameter is set, it is properly changed using the extracted information on the ROI. In addition, the extracted information on the ROI is hidden in the level value. If the information on the ROI is hidden in the quantization parameter and the value of the level, the encoded data value is slightly changed, but the encoding data does not increase. Also, the picture quality is not changed. These sequential procedures are shown in FIG. 5.

Meanwhile, the information that is difficult to accurately estimate at the decoder if there is no information on the ROI, which is transmitted through the data hiding, is hidden and transmitted. Such information includes the position of the ROI, the motion vector, the information on the encoding type, etc.

If the above information for the whole images is hidden and transmitted, the error can be concealed well. However, positions in which data can be hidden are not sufficient and the user recognizes greatly the degradation of the picture quality in the ROI when the error occurs, so that only the information on the ROI is hidden. The reason for hiding the motion vector and the information on the encoding type as well as the position of the ROI is due to the characteristic of the video compression method.

In the video compression, important information is drawn out to the header and only a small amount of data is actually encoded and transmitted. The motion vector is used to find the position most similar to the previous image by macroblock unit in order for the video data compression. If the most similar position is found and transmitted using the motion vector, an amount of encoding data can be greatly reduced because the actually encoding data is only a difference value from the previous image.

However, if the information on the motion vector is lost during the communication, it is difficult to perform the accurate error concealment because the actually encoded data is only the difference value from the previous image. In other words, the accurate error concealment is difficult because it does not know which portion of the previous image the information is taken from. Since the motion vector cannot be accurately found at the decoder, the error concealment is performed using motion vectors of the surrounding macroblocks.

In case the motion vector has no similarity to the surrounding macroblock, it results in a new error insertion into the reconstructed image. Thus, it causes the degradation in the quality of following images. Therefore, the information on the accurate motion vector may be an important information on the error concealment. In other words, if the ROI is extracted at the encoder and then an average motion vector of each macroblock or a common string is hidden and transmitted, the decoder extracts the hidden data and finds more accurate motion vector, thereby performing the effective error concealment.

Also, the encoding type is an important information that is necessary for the error concealment. In the general video compression system, the encoding type is classified into an intra type and an inter type.

In the intra type, the image itself is DCTed and quantized without finding the similar position in the previous image. In other words, since the previous image is not referred, an amount of encoding data is large but there is no influence from the error of the previous image.

In the inter type, after finding the similar position in the previous image, the motion vector is found and only its difference value is encoded. In other words, since only the difference value from the most similar position is encoded with reference to the previous image, an amount of data is small but there is an influence from the error of the previous image.

Accordingly, the decoding in an incorrect encoding type results in a new error insertion into the restructured image. For example, if the intra type is incorrectly set as the inter type, unnecessary motion vector is found and incorrect difference image is taken. In addition, if the inter type is incorrectly set as the intra type, the image is reconstructed using only the difference value from the previous image, so that the picture quality is degraded seriously.

The above-described important information is mainly the header information. In the encoding, a large amount of information is embedded into the header and a small amount of data is compressed. Therefore, if the header information is lost, it is impossible to reconstruct the following data. Therefore, the data hidden through the data hiding are also the header information of the ROI.

An error rate in the moving picture communication is differently charged depending on environments. The error rate is 10E-3 in a serious case and there is an environment having almost no error. In an environment having high error rate, the hiding data must be repeatedly transmitted several times since the data may be broken due to the error. If there occurs an error in the reconstructing data, the hidden data is extracted and the error is concealed. Since the data hiding itself is hidden in the encoding bit stream, the hidden data is also broken if the encoded data is broken due to the error.

If the error concealment is performed using the broken information, the degradation of the picture quality becomes more serious. Therefore, the data to be hidden are repeatedly transmitted several times. In this manner, even when the hidden data is broken due to the error, the other data repeated can be used at the decoder.

In case of the related art error concealment method, the image is reconstructed maximally similar to the original image using only the received image at the decoder. In other words, since available information is limited, there is a difference between the reconstructed image and the original image. The general video compression is performed using the difference value from the previous image. Therefore, once an error occurs at a specific time point, the error is propagated to next images as long as the error is not removed perfectly. In other words, it is necessary to remove the error extremely.

The moving picture coding method according to the present invention can remove the error extremely because the error concealment is performed using the additional information at both the receiver and the transmitter.

The moving picture coding method according to the present invention provides more efficient error concealment when the error occurs in the video communication such as IMT-2000. Thus, the moving picture coding method can be effectively used in the moving picture communication services, which employ general video codec standard (H.26X, MPEG 1, 2, 4).

According to the present invention, when the multimedia images are transmitted through the network, the error concealment can be efficiently processed with respect to the error occurring in the decoding process by providing the information on ROI through the data hiding in the encoding process.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A moving picture coding method of a moving picture transmission system, comprising the steps of:
extracting an information on region of interest(ROI) of an inputted image at an encoder;
transmitting the extracted information on the ROI through data hiding; and
performing an error concealment using the information on the ROI at a decoder.

2. The moving picture coding method according to claim 1, further comprising the step of extracting the information on the ROI from the data hiding at the decoder before the error concealment is performed.

3. The moving picture coding method according to claim 1, wherein the ROI is a region that a user views more concentratedly than other regions when the user views one screen image.

4. The moving picture coding method according to claim 1, wherein the ROI is a character display region in an image including a character.

5. The moving picture coding method according to claim 1, wherein the information on the ROI is extracted using an object extraction technology.

6. The moving picture coding method according to claim 1, wherein the information on the ROI includes a position of the ROI, a motion vector, and an information on the encoding type.

7. The moving picture coding method according to claim 1, wherein the data hiding hides a header information of the ROI.

8. The moving picture coding method according to claim 1, wherein the data hiding repeatedly hides a header information of the ROI two or more times.

9. The moving picture coding method according to claim 1, wherein the data hiding is performed using a quantization parameter with respect to the inputted image and/or a level value of a block in which DCT (discrete cosine transform) is performed.

10. The moving picture coding method according to claim 9, wherein the level value is given by dividing DCT coefficient by the quantization parameter.
